(19) United States
(12) Patent Application Publication
(10) Pub. No.: US 2026/0233421 A1
(43) Pub. Date: Aug. 13, 2026

(54) HAIR CLIPPER SYSTEM WITH DISTANCE-BASED AUTOMATED BLADE ADJUSTMENT

(71) Applicant: Cristiano Coccolini, Port Saint Lucie, FL (US)

(72) Inventor: Cristiano Coccolini, Port Saint Lucie, FL (US)

(21) Appl. No.: 19/432,706

(22) Filed: Dec. 24, 2025

Related U.S. Application Data
(60) Provisional application No. 63/757,744, filed on Feb. 12, 2025.

(51) Int. Cl. B26B 19/38; B26B 19/06; B26B 19/20

(52) U.S. Cl. CPC B26B 19/388; B26B 19/06; B26B 19/205; B26B 19/3886

(57) ABSTRACT

A hair clipper system for producing automated, precise fade haircuts is disclosed. The system includes a sensor configured to measure a distance traveled along a surface of a scalp, a microcontroller operatively coupled to the sensor, first and second blades positioned for relative movement, and an actuator configured to adjust a cutting length. Upon actuation of an initiation button, distance data measured by the sensor is transmitted to the microcontroller, which generates control signals to move one blade relative to the other in direct proportion to the distance traveled. The system may continuously adjust the blade position in real time to create a graduated fade. The sensor may detect forward and backward movement, and a reset function returns the system to an initial position. The system enables consistent, automated fade transitions with reduced user skill requirements.

### CROSS-REFERENCE TO RELATED APPLICATIONS

This application claims priority to U.S. Provisional Patent Application No. 63/757,744, filed Feb. 12, 2025 which is incorporated by reference for all purposes as if fully set forth herein.

### BACKGROUND

Hair clippers are widely used in both professional barbering and personal grooming to cut hair to a desired length. One of the most technically demanding haircut styles is a fade, in which hair length transitions gradually and smoothly from shorter lengths near a lower region of the scalp to longer lengths higher on the scalp. Achieving a consistent and visually appealing fade typically requires significant skill, experience, and manual control by the user. Even for trained professionals, producing a precise and repeatable fade can be time-consuming and subject to user fatigue, inconsistent hand movement, or variations in technique.

Conventional hair clippers generally rely on fixed blade positions or manually adjustable guards and levers to control cutting length. While these mechanisms allow discrete length adjustments, they do not automatically adapt to how far the clipper has traveled across the scalp. As a result, users must manually coordinate clipper movement with blade adjustment in real time to create a gradual transition in hair length. This manual coordination can be difficult to master and may lead to uneven fades, visible lines, or inconsistent results, particularly for inexperienced users or individuals cutting their own hair.

Some existing grooming devices include electronic components or motorized adjustments; however, these devices typically do not measure the distance traveled across the scalp or dynamically adjust blade position in direct relation to that distance. Without real-time feedback based on clipper movement, current systems are unable to automatically generate precise, proportional changes in cutting length that correspond to the physical motion of the clipper during use.

Accordingly, there is a need for an improved hair clipper system that assists users in producing accurate, repeatable, and automated fade haircuts. Such a system would benefit from the ability to measure the distance traveled across the scalp, process that information using a control system, and automatically adjust blade position in proportion to the measured movement. By incorporating sensor-based distance measurement, microcontroller-driven control logic, and actuator-controlled blade adjustment, an automated system could reduce reliance on user skill, improve consistency, and enable precise fade transitions across a range of fade styles.

### SUMMARY

The present disclosure relates to a hair clipper system configured to automatically adjust cutting length based on movement of the clipper across a scalp. The system includes a sensor configured to measure a distance traveled along the scalp, a microcontroller operatively coupled to the sensor, and an actuator configured to move a blade assembly in response to distance measurements. The system further includes a first blade and a second blade, wherein the second blade is movable along a length axis of the first blade to vary cutting depth.

In operation, upon actuation of an initiation button, the sensor detects distance traveled across the scalp and transmits corresponding distance data to the microcontroller. The microcontroller generates control signals that drive the actuator to move the second blade in direct proportion to the measured distance. In certain embodiments, the first blade is tapered along its length such that movement of the second blade along the tapered axis produces a graduated cutting depth, thereby generating an automated fade. A reset button may be provided to return the blade position and distance measurement to an initial zero state.

In some embodiments, the sensor comprises a rotary encoder configured to generate pulse signals corresponding to scalp movement. The microcontroller may be further configured to determine whether the distance traveled is increasing or decreasing and to move the second blade upward or downward accordingly. In additional embodiments, the microcontroller continuously receives updated distance data during clipper movement and dynamically adjusts blade position in real time to form a feedback control loop.

The system may be configured to produce different fade profiles by controlling the ratio of blade movement to distance traveled, including high-fade, mid-fade, and low-fade transitions. The disclosed system enables consistent, repeatable, and automated adjustment of cutting length during use, reducing reliance on manual blade control and facilitating precise fade haircuts.

### BRIEF DESCRIPTION OF THE DRAWINGS

FIG. 1 is a perspective view of a hair clipper system incorporating an automated fade system in accordance with one or more embodiments of the present disclosure.

FIG. 2 is another perspective view illustrating a sensor, a microcontroller, and an actuator of the hair clipper system.

FIG. 3 is another perspective view of a hair clipper system incorporating an automated fade system in accordance with one or more embodiments of the present disclosure.

### DETAILED DESCRIPTION

The accompanying drawings are provided for purposes of illustration only and are not intended to limit the scope of the disclosure. The figures depict exemplary embodiments of the hair clipper system and its components; however, the relative dimensions, shapes, proportions, and arrangements shown in the drawings are not necessarily to scale and may be exaggerated, reduced, simplified, or omitted for clarity.

It will be understood that additional or alternative components, structures, and configurations may be used without departing from the spirit and scope of the disclosure. The embodiments shown in the drawings are representative examples, and variations, substitutions, or modifications may be made to the illustrated embodiments by those of ordinary skill in the art while remaining within the scope of the appended claims.

Accordingly, the drawings are to be regarded as illustrative rather than restrictive, and the scope of the disclosure is defined by the claims and their equivalents rather than by the specific embodiments shown in the figures.

In some embodiments, the actuator is mechanically connected directly to the second blade. In other embodiments, the actuator is operatively coupled to the second blade through one or more intermediate components configured to translate, amplify, reduce, or redirect motion generated by the actuator. The particular configuration of mechanical coupling may vary without departing from the scope of the disclosure, provided that movement of the actuator results in corresponding movement of the second blade relative to the first blade.

In some embodiments, the automated adjustment of cutting length is achieved by moving the first blade relative to the second blade, rather than moving the second blade. In such embodiments, the actuator is operatively coupled to the first blade and is configured to translate the first blade along the length axis in response to control signals generated by the microcontroller based on distance data received from the sensor.

In some embodiments, the actuator is configured to move the second blade relative to the first blade. In other embodiments, the actuator is configured to move the first blade relative to the second blade. In still other embodiments, both the first blade and the second blade may be movable by the actuator. In each embodiment, relative movement between the first blade and the second blade adjusts a cutting length in accordance with distance data measured by the sensor.

In some embodiments, the sensor configured to measure the distance traveled along the surface of the scalp comprises a rotary encoder, including an incremental rotary encoder or an absolute rotary encoder, configured to generate signals corresponding to rotational movement of a wheel or roller in contact with the scalp. In some embodiments, the sensor comprises a linear encoder configured to measure translational movement of the hair clipper housing relative to the scalp. In some embodiments, the sensor comprises an optical sensor, including an optical flow sensor or a camera-based sensor, configured to detect relative motion between the hair clipper and the scalp by tracking surface features or movement patterns. In some embodiments, the sensor comprises an inertial measurement unit (IMU) including one or more accelerometers, gyroscopes, or magnetometers, configured to estimate distance traveled based on motion data. In some embodiments, the sensor comprises a mechanical contact sensor, including a wheel-based odometer or friction roller, configured to rotate as the hair clipper moves across the scalp. In some embodiments, the sensor comprises a capacitive or proximity sensor configured to infer movement along the scalp based on changes in proximity or contact characteristics. In some embodiments, the sensor comprises an ultrasonic sensor or a time-of-flight sensor configured to determine relative displacement during movement across the scalp. In some embodiments, the sensor comprises a magnetic sensor configured to detect movement based on changes in a magnetic field. In some embodiments, the sensor comprises a combination of two or more of the foregoing sensors, and the microcontroller is configured to fuse sensor data to improve accuracy, reliability, or robustness of distance measurements.

In all embodiments, the term “distance traveled” refers to a cumulative measure of relative movement between the hair clipper and the scalp surface, regardless of the specific sensing technology used to obtain the measurement.

### Reference Numeral Chart

### Reference Numeral Description

100 Hair clipper system
110 Downward section
120 Upward section
200 First blade
210 Length of first blade
220 Width of first blade
300 Second blade
310 Length of second blade
320 Width of second blade
400 Microcontroller
500 Actuator
600 Sensor
700 Initiation button
800 Reset button

### Detailed Description of the Embodiments

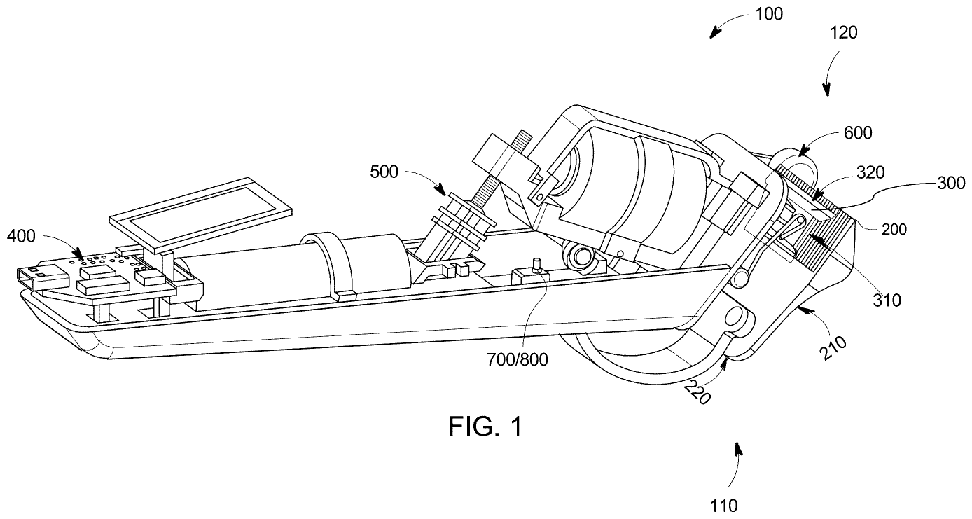

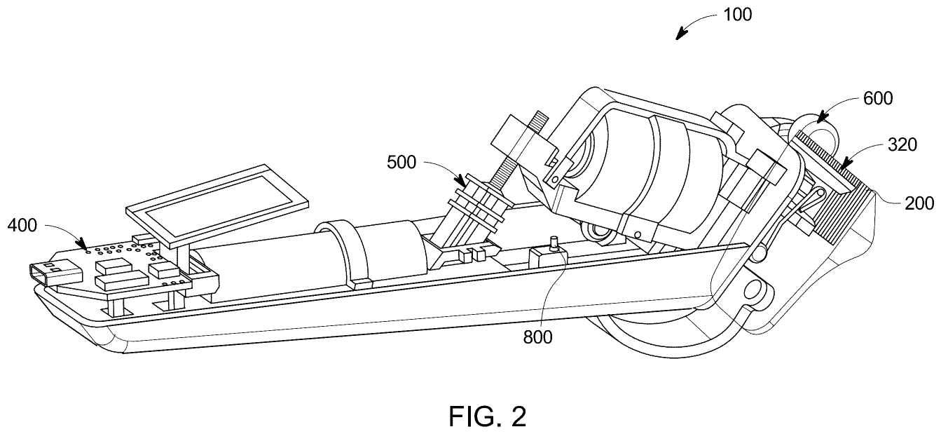

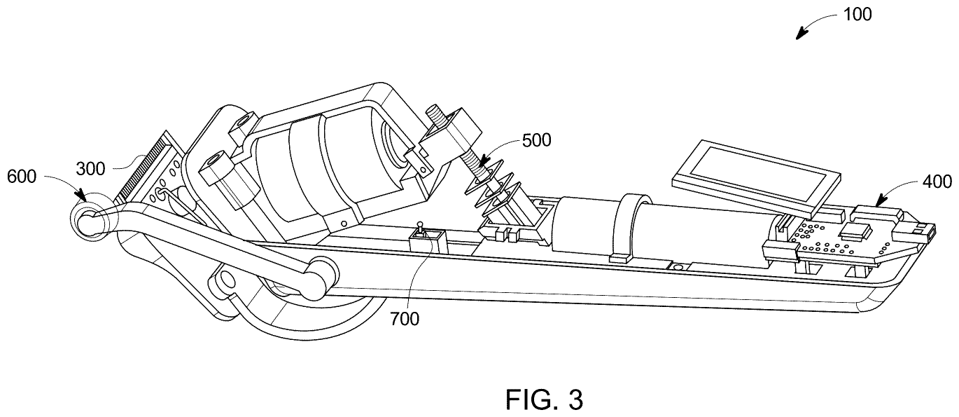

Referring now to the drawings, wherein like reference numerals designate identical or corresponding elements throughout the several views, FIGS. 1-3 illustrate embodiments of a hair clipper system 100 incorporating an automated fade mechanism.

### Overall System Architecture

As shown in FIG. 1, the hair clipper system 100 includes a housing having a downward and an upward section 120. The system 100 includes a first blade 200 and a second blade 300 mounted at a distal end of the housing. The blades cooperate to cut hair as the clipper is moved across the scalp.

The first blade 200 has a length 210 and a width 220. The second blade 300 likewise has a length 310 and a width 320. In the illustrated embodiments, the second blade 300 is positioned to move longitudinally along the length 210 of the first blade 200. Relative movement between the first blade 200 and the second blade 300 alters the effective cutting length of the clipper.

The system further includes a sensor 600, a microcontroller 400 operatively coupled to the sensor, and an actuator 500 operatively coupled to at least one of the blades and the microcontroller. An initiation button 700 and a reset button 800 are provided on the housing to control operation of the automated fade functionality. The initiation button 700 and the reset button 800 are operatively coupled to the microcontroller 400 and are configured to transmit user input signals to the microcontroller to initiate, control, or reset operation of the automated fade functionality.

### Sensor and Distance Measurement

The sensor 600 is configured to measure a distance traveled by the hair clipper system 100 along the surface of the scalp during use. In some embodiments, the sensor 600 comprises a rotary encoder, such as an incremental or absolute rotary encoder, coupled to a wheel or roller that contacts the scalp. As the clipper moves, the roller rotates, and the rotary encoder generates pulse signals corresponding to rotational movement, which are proportional to linear distance traveled along the scalp surface.

In other embodiments, the sensor 600 may comprise alternative distance-measuring devices, including but not limited to linear encoders, optical flow sensors, inertial measurement units, or combinations thereof. Regardless of sensor type, the term “distance traveled” refers to a cumulative measure of relative movement between the hair clipper system 100 and the scalp.

In embodiments the rotary encoder is configured to detect both forward and backward movement. Forward motion generates a first signal indicating increasing distance, while backward motion generates a second signal indicating decreasing distance.

### Microcontroller Operation and Control Logic

The microcontroller 400 receives distance data from the sensor 600 and processes the data according to stored control logic. Upon actuation of the initiation button 700, the microcontroller 400 begins monitoring sensor output and continuously updates a distance value representing movement of the clipper across the scalp.

The microcontroller 400 is configured to generate control signals to the actuator 500 that cause movement of the second blade 300 along the length axis of the first blade 200 in direct proportion to the measured distance. As used herein, “direct proportion” includes linear proportional relationships as well as scaled ratios selected to achieve desired fade profiles.

In some embodiments, the microcontroller determines whether the measured distance is increasing or decreasing. If distance increases, the microcontroller issues commands to move the blade in a first direction; if distance decreases, the microcontroller issues commands to move the blade in an opposite direction.

### Actuator and Blade Movement

The actuator 500 may comprise an electric motor, stepper motor, linear actuator, solenoid, or other electromechanical device capable of precise positional control. The actuator 500 is operatively coupled to the second blade 300 either directly or through intermediate mechanical components such as linkages, cams, lead screws, or gears.

In response to control signals from the microcontroller 400, the actuator 500 moves the second blade 300 along the length 210 of the first blade 200. In some embodiments, movement of the second blade adjusts the blade overlap to vary cutting length.

In embodiments, the microcontroller applies predefined ratios between distance measured by the sensor and blade movement. For example, the actuator may move the second blade between approximately 0.15 mm and 0.25 mm per millimeter of distance measured by the sensor to generate a high-fade transition, between approximately 0.10 mm and 0.20 mm per millimeter for a mid-fade transition, or between approximately 0.05 mm and 0.15 mm per millimeter for a low-fade transition.

### Tapered Blade and Automated Fade

In some embodiments the first blade 200 comprises a tapered static blade. The taper extends along the length 210 of the blade, transitioning from a minimum cutting depth at a first end, including a zero-cut or near-zero cutting depth (e.g., approximately 0 mm to 1 mm), to a longer cutting depth (e.g., up to approximately 2 inches) at an opposite end.

As the second blade 300 moves along the tapered axis of the first blade, the effective cutting depth changes gradually, producing an automated fade effect. This enables consistent and repeatable fade haircuts without requiring manual adjustment by the user.

In some embodiments, the first blade 200, the second blade 300, or both blades comprise a cutting edge having a curved or contoured profile along at least a portion of a blade length. In such embodiments, the curved or contoured cutting edge is configured to conform to an anatomical contour of a user, including a perimeter region of an ear, to facilitate trimming in regions adjacent to the ear and to improve control during outlining or blending operations. The curved or contoured cutting edge may be arcuate, concave, convex, or a combination thereof, and may extend along an entire length of the blade or only along a localized portion of the blade.

### Feedback Control Loop

In some embodiments the microcontroller 400 continuously receives updated distance data from the sensor 600 while the clipper is in motion. The microcontroller dynamically adjusts the actuator position in real time, forming a closed-loop feedback control system. This ensures smooth transitions, compensates for changes in user motion, and maintains consistent fade profiles across the scalp.

### Button Functionality

The initiation button 700 is configured to activate distance measurement and automated blade control when activated. The reset button 800 resets the system by returning the actuator 500 to an initial zero position and clearing the stored distance value.

In embodiments corresponding to claim 13, the initiation button 700 and reset button 800 are implemented as a single multifunction button. A first activation initiates measurement and control, while a subsequent activation resets the actuator and sensor to their initial states.

### Directional Movement

In some embodiments, forward movement of the clipper along the scalp causes the actuator 500 to advance the blade in a first direction (e.g., downward along the blade length), while backward movement causes of the clipper causes the actuator to move the blade a second direction (e.g., upward along the blade length).

The disclosed embodiments describe concrete structures, electrical components, control logic, and mechanical interactions sufficient to enable a person of ordinary skill in the art to make and use the claimed hair clipper system without undue experimentation. Variations in sensor type, actuator type, blade geometry, and control algorithms may be implemented without departing from the scope of the claims.

As used herein, the ‘zero position’ refers to a reference or home position of the actuator in which the relative positioning of the first blade and the second blade produces a lowest or minimum cutting length of the hair clipper system.

As used herein, the term “microcontroller” refers to any control or processing circuitry configured to perform the disclosed functions, and is not limited to a discrete microcontroller integrated circuit. In various embodiments, the microcontroller may comprise or be replaced by one or more processors, processing units, control circuits, application-specific integrated circuits (ASICs), field-programmable gate arrays (FPGAs), system-on-chip (SoC) devices, digital signal processors (DSPs), or combinations thereof, executing firmware, software, hardware logic, or any combination thereof to perform the disclosed control operations.

What is claimed is

1. A hair clipper system comprising:
a sensor configured to measure a distance traveled along a surface of a scalp;
a microcontroller operatively coupled to the sensor;
a first blade and a second blade, each having a length and a width, the second blade being positioned to move along the length of the first blade;
an actuator operatively coupled to the second blade;
an initiation button; and
a reset button;
wherein, upon actuation of the initiation button, the sensor is configured to detect the distance traveled across the scalp and transmit corresponding distance data to the microcontroller;
wherein the microcontroller is configured to generate control signals to the actuator to move the second blade along the length axis of the first blade in direct proportion to the measured distance; and
wherein, upon actuation of the reset button, the actuator is configured to return the second blade to an initial zero position and the sensor is configured to reset the measured distance to zero.

2. The hair clipper system of claim 1, wherein the first blade is tapered along its length such that movement of the second blade along the tapered axis produces a graduated cutting depth to generate an automated fade.

3. The hair clipper system of claim 1, wherein the sensor comprises a rotary encoder configured to generate pulse signals corresponding to the distance traveled along the surface of the scalp.

4. The hair clipper system of claim 1, wherein the microcontroller is further configured to determine whether the measured distance is increasing or decreasing and, based on that determination, to transmit control signals to the actuator to move the second blade upward or downward along the first blade in correspondence with the positive or negative change in distance traveled.

5. The hair clipper system of claim 1, wherein the actuator is configured to adjust the position of the second blade to provide cutting lengths ranging from about 0.1 millimeters to up to 2 inches based on up to approximately 6 inches of distance traveled along the scalp.

6. The hair clipper system of claim 1, wherein the first blade comprises a tapered static blade configured to provide a varying cutting depth along its length.

7. The hair clipper system of claim 6, wherein the tapered static blade transitions from a cutting depth of approximately 1 millimeter at a first end to up to 2 inches at an opposite end.

8. The hair clipper system of claim 1, wherein the microcontroller is further configured to repeatedly receive updated distance data from the sensor during movement of the clipper across the scalp and to continuously adjust the position of the second blade in real time based on the updated distance data, thereby forming a dynamic feedback control loop.

9. The hair clipper system of claim 1, wherein the microcontroller is configured to control the actuator such that the second blade moves between 0.15 millimeters and 0.25 millimeters for each 1 millimeter of distance traveled along the scalp to produce a high-fade transition.

10. The hair clipper system of claim 1, wherein the microcontroller is configured to control the actuator such that the second blade moves between 0.10 millimeters and 0.20 millimeters for each 1 millimeter of distance traveled along the scalp to produce a mid-fade transition.

11. The hair clipper system of claim 1, wherein the microcontroller is configured to control the actuator such that the second blade moves between 0.05 millimeters and 0.15 millimeters for each 1 millimeter of distance traveled along the scalp to produce a low-fade transition.

12. The hair clipper system of claim 1, wherein the sensor comprises a rotary encoder configured to detect both forward and backward movement along the surface of the scalp, wherein detection of forward movement causes the rotary encoder to transmit a first signal to the microcontroller, the microcontroller being configured to generate a corresponding control signal that drives the actuator to move the second blade downward along the length of the first blade, and wherein detection of backward movement causes the rotary encoder to transmit a second signal to the microcontroller, the microcontroller being configured to generate a corresponding control signal that drives the actuator to move the second blade upward along the length of the first blade.

13. The hair clipper system of claim 1, wherein the initiation button and the reset button comprise a single multifunction button, and wherein a first actuation of the multifunction button initiates measurement of the distance traveled by the sensor and control of the actuator, and a subsequent actuation of the multifunction button resets the actuator to the initial zero position and resets the measured distance to zero.
